(19) United States
(12) Patent Application Publication
(10) Pub. No.: US 2016/0272017 A1
(43) Pub. Date: Sep. 22, 2016

(54) TIRE INFLATION-DEFLATION RESPONSE SYSTEM

(71) Applicant: Ford Global Technologies LLC, Dearborn, MI (US)

(72) Inventors: Mahmoud Yousef GHANNAM, Canton, MI (US); Aed M. DUDAR, Canton, MI (US)

(21) Appl. No.: 14/660,974

(22) Filed: Mar. 18, 2015

(51) Int. Cl. B60C 23/02; G07C 5/08; B60T 8/172; G07C 5/00; B60T 7/12; B29C 73/16

(52) U.S. Cl. CPC B60C 23/02; B60T 7/12; B29C 73/166; B60T 8/1725; G07C 5/006; G07C 5/0833; G07C 5/0825

(57) ABSTRACT

A method of controlling a vehicle includes providing a driver alert in response to a detected tire pressure deviation from a nominal tire pressure exceeding a first threshold. The method additionally includes providing audio or visual directions to a service station in response to the detected tire pressure deviation from the nominal tire pressure exceeding a second threshold. The second threshold is distinct from the first threshold.

### TECHNICAL FIELD

The present disclosure relates to systems and methods for monitoring a tire pressure status and responding to deviations from a nominal tire pressure.

### BACKGROUND

Tire pressure monitoring (TPM) systems may be installed in vehicles to provide a vehicle operator information pertaining to the condition of vehicle tires. Such systems generally include an on-vehicle controller configured to communicate with sensors provided in the vehicle tires. The controller and sensors may communicate wirelessly. The sensors are configured to measure tire pressure and transmit the measured value to the controller. In many TPMS systems, the controller is configured to activate a dashboard alert light when a tire pressure measurement in any of the tires falls below a pre-set value.

### SUMMARY

A system and method of controlling a vehicle according to the present disclosure includes providing a driver alert in response to a detected tire pressure deviation from a nominal tire pressure exceeding a first threshold. The system and method additionally include providing audio or visual directions to a service station in response to the detected tire pressure deviation from the nominal tire pressure exceeding a second threshold. The second threshold is distinct from the first threshold.

In one embodiment, the method further includes releasing sealant material into a tire in response to the detected tire pressure deviation exceeding a third threshold and the tire pressure deviation being a decrease in tire pressure. The third threshold may be between the first threshold and the second threshold. In such embodiments, the sealant material may not be released when the tire pressure deviation exceeds the second threshold.

In some embodiments, the method additionally includes automatically engaging vehicle brakes in response to the detected tire pressure deviation exceeding a fourth threshold. In additional embodiments, the method further includes activating a tire deflator in response to the detected tire pressure deviation exceeding a fifth threshold and the tire pressure deviation being an increase in tire pressure.

A vehicle according to the present disclosure includes a tire, a sensor configured to monitor pressure within the tire, and a controller. The controller is configured to signal a first driver alert in response to a first reading from the sensor indicating a pressure deviation from a nominal tire pressure exceeding a first threshold and control an audiovisual system to provide audio or visual directions to a service station in response to a second reading indicating a pressure deviation exceeding a distinct second threshold.

In some embodiments, the vehicle additionally includes a sealant material dispenser disposed within the tire. In such embodiments, the controller is further configured to control the sealant material dispenser to release sealant material into the tire in response to the deviation exceeding a calibratable third threshold. In such embodiments, the sealant material dispenser and sensor may be integrated into a single module. The third threshold may be between the first and second thresholds. In such embodiments, the controller may be configured to control the sealant material dispenser to release sealant material into the tire in response to the deviation being greater than the third threshold only when the deviation is also less than the second threshold.

In some embodiments, the controller is further configured to engage vehicle brakes in response to the pressure deviation exceeding a fourth threshold. The controller may be further configured to activate a tire deflator in response to the pressure deviation exceeding a fifth threshold.

A method of controlling a vehicle according to the present disclosure includes providing a driver alert in response to a magnitude of a detected reduction in tire pressure exceeding a first threshold and not exceeding a second threshold. The method additionally includes automatically releasing sealant material into a tire in response to the magnitude of the detected reduction in tire pressure exceeding the second threshold and not exceeding a third threshold. The method further includes automatically providing audio or visual directions to a service station in response to the magnitude of the detected reduction in tire pressure exceeding the third threshold.

Some embodiments additionally include automatically engaging vehicle brakes in response to the detected tire pressure deviation exceeding a fourth threshold. Such embodiments may further include automatically calling a vehicle service location in response to the detected tire pressure deviation exceeding the fourth threshold.

In some embodiments, the detected reduction in tire pressure is detected based on a difference between a measured tire pressure and an expected tire pressure based on a tire pressure model.

Embodiments according to the present disclosure provide a number of advantages. For example, the present disclosure provides systems and methods for providing detailed information regarding tire pressure to a driver. In addition, systems and methods according to the present disclosure may take various passive and active measures in response to changes in tire pressure.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic view of a representative vehicle according to one embodiment of the present disclosure;

FIG. 2 illustrates a method of controlling a vehicle according to the present disclosure in flowchart form; and

FIG. 3 illustrates a tire pressure modeling and monitoring method according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

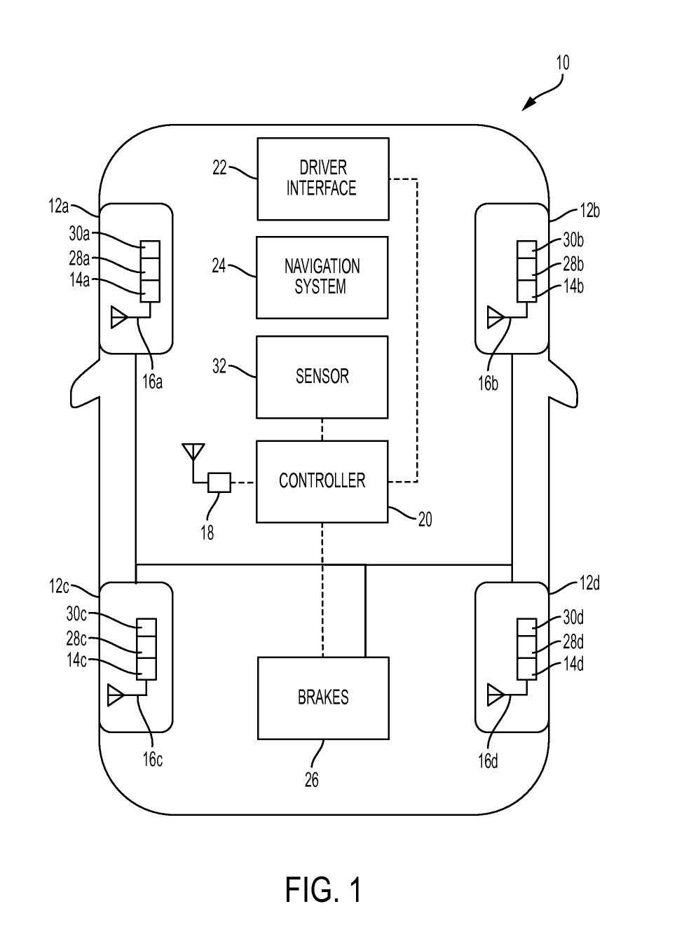

FIG. 1 shows a non-limiting exemplary embodiment of a tire pressure monitoring system (TPMS) of a vehicle 10. The vehicle 10 includes wheels 12a-d, each with associated tires (not numbered). One or more tire sensors 14a-14d are disposed in one or more of the tires 12a-12d. In this embodiment, tire sensor 14a is be disposed in the left, front wheel 12a, tire sensor 14b is disposed in the right, front wheel 12b, tire sensor 14c is disposed in the left, rear wheel 12c, and tire sensor 104d is disposed in the right, rear wheel 12d.

Tire sensors 14a-d may be installed onto one or more wheels as part of the TPMS in order to detect the pressure status of one or more vehicle tires. Furthermore, tire sensors 14a-d may periodically monitor or sample tire pressure for making a pressure determination. For example, tire sensors 14a-d may monitor tire pressure every 15 minutes. The period(s) at which the sensors 14a-d may monitor the tire pressure may vary depending on the preferences of the vehicle manufacturer.

Tire sensor(s) 14a-d may have different modes for monitoring tire pressure. Non-limiting examples of tire sensor modes include a rotating mode (i.e., wheels are moving), a stationary mode (i.e., wheels have been stationary for an extended period of time, e.g., greater than 15 minutes), and an interim mode (i.e., a predetermined time (e.g., 15 minutes) between a tire pressure event (including, but not limited to, wheel motion) and the stationary mode). The monitoring periods may also vary depending on the mode in which the tire sensors 14a-d are operating. For example, in a rotating mode, tire sensors 14a-d may monitor tire pressure every 5 seconds. In stationary mode, tire sensors 14a-d may monitor tire pressure less frequently (e.g., every minute). In the interim mode, the sensors 14a-d may monitor tire pressure every 2 seconds. The mode in which the tires are operating may be based on signal(s) transmitted from a motion sensor(s) communicating with tire pressure sensor(s) 14a-d indicating a movement status of the tires. Furthermore, one or more timers may be installed in sensor(s) 14a-d for measuring the span of the interim period.

During a tire pressure event (i.e., an event effecting tire pressure including, but limited to, an inflation event or deflation event), tire sensors 14a-d may enter a rapid pressure change mode (RPC). In RPC mode, sensors 14a-d may transmit the monitored tire pressure data obtained from the one or more tires. Transmission rates may vary depending on vehicle manufacturer preferences. In one non-limiting embodiment, the tire pressure data may be transmitted in the range of every 15 to 30 seconds.

The tire pressure sensors 14a-d are provided with transmitters 16a-16d, respectively. The transmitters may be radio frequency transmitters or other appropriate transmitters. The transmitters 16a-16d are configured to transmit tire pressure data to a TPMS receiver 18 for transmission to at least one vehicle controller 20. The TPMS receiver 18 may be a radio frequency receiver module installed in the vehicle. Accordingly, in one non-limiting embodiment, the tire pressure data from the sensor 14a-d may be transmitted as radio frequency signals to the TPMS receiver 18.

TPMS receiver 18 may be in communication with the controller 20 over a vehicle communication network which may include, without limitation, CAN, J-1850, GMLAN. The vehicle communication network may facilitate unilateral and/or bilateral data exchange (e.g., data from and/or to sensor(s) 14a-d) between the TPMS receiver 18 and controller 20. It should be understood that the architecture is non-limiting and may be modified and/or re-arranged without departing from the scope of the various embodiments. By way of example and not limitation, TPMS receiver 18 may be a component of controller 20 rather than as a separate component as illustrated in FIG. 1.

The controller 20 may be disposed in the vehicle and may receive tire inflation status data from tire pressure sensor(s) 14a-d. The controller 20 may include programmable instructions (or an algorithm) for determining tire inflation/deflation status. For example, as will be described below, a TPMS algorithm may determine a tire pressure level measured in pound-force per square inch (psi), kiloPascal (kPa), bars, or other pressure units. As another non-limiting example, the TPMS algorithm may measure the rate of inflation/deflation which may be measured in, as a non-limiting example, units of time (e.g., seconds). It should be understood that the units of measurement used in these examples are non-limiting and other units may be utilized without departing from the scope of the various embodiments.

The controller 20 may transmit the tire inflation/deflation status to one or more components of the vehicle for transmitting a status message to a user. A non-limiting example of a user is any individual inflating/deflating the vehicle's tires such as a vehicle owner, user, or service technician. Non-limiting examples of vehicle components to which one or more inflation/deflation status messages may be transmitted include a driver interface 22, which may comprise vehicle lights, a vehicle audio system, a vehicle instrument cluster, a multi-function display, or combinations thereof.

In addition, the controller 20 is configured to communicate with or control additional vehicle components. A non-limiting example includes a navigation system 24. The navigation system 24 may include a GPS, AGPS, GLONASS, or other positioning receivers. The controller 20 is configured to receive vehicle position information from the navigation system 24.

The controller 20 is also configured to communicate with or control at least one sensor 32. The sensors 32 may include a steering wheel position sensor configured to detect a position of a vehicle steering wheel. The sensors 32 may include seat belt sensors or occupant sensors configured to detect the presence of an occupant in a seat. The sensors 32 may include a road grade sensor configured to detect a road grade at a current vehicle location. The sensors 32 may include ambient pressure and/or temperature sensors. The sensors 32 may include a moisture sensor system configured to detect the presence of rain, snow, or other precipitation. The sensors 32 may include any combination of the above and/or additional sensors.

In addition, the controller 20 is configured to communicate with or control vehicle brakes 26. The vehicle brakes 26 may include friction brakes and/or a regenerative braking system. The vehicle brakes 26 are configured to apply braking torque to the wheels 12a-d. The messages to the one or more vehicle components may be transmitted over a vehicle communication network which may include, without limitation, CAN, J-1850, GMLAN.

The wheels 12a-d are also provided with tire sealant material devices 28a-d. The tire sealant material devices 28a-d are configured to, when activated, release a tire sealant material into the interior of a tire. The tire sealant material will be subjected to suction forces due to a pressure difference between the pressure inside the tire and an ambient pressure outside the tire. The suction force will generally drive the material to flow toward the opening. Due to material properties of the tire sealant material and temperature and/or pressure changes from the interior to exterior of the tire, the tire sealant material may adhere to and solidify about a puncture through the wall of the tire. The material may thus build up across the puncture and close it.

In a preferred embodiment, the tire sealant material devices 28a-d are integrated with the respective tire pressure sensors 14a-d. In other words, the tire sealant material device 28a is integrated with the tire pressure sensor 14a, the tire sealant material device 28b is integrated with the tire pressure sensor 14b, the tire sealant material device 28c is integrated with the tire pressure sensor 14c, and the tire sealant material device 28d is integrated with the tire pressure sensor 14d. However, in alternate embodiments the tire sealant material devices 28a-d are provided as separate modules from the respective tire pressure sensors 14a-d. The tire sealant material devices 28a-d are in communication with or under the control of the controller 20.

The wheels 12a-d are further provided with tire deflator devices 30a-d. The tire deflator devices 30a-d are configured to, when activated, deflate the tire associated with the respective tire deflator device 30a-d. While illustrated as proximate the tire pressure sensors 14a-d and tire sealant material devices 28a-28d, the tire deflator devices 30a-d may be provided as separate modules. The tire deflator devices 30a-d are in communication with or under the control of the controller 20.

It should be understood that the arrangement of FIG. 1 is non-limiting and may be modified without departing from the scope of the various embodiments.

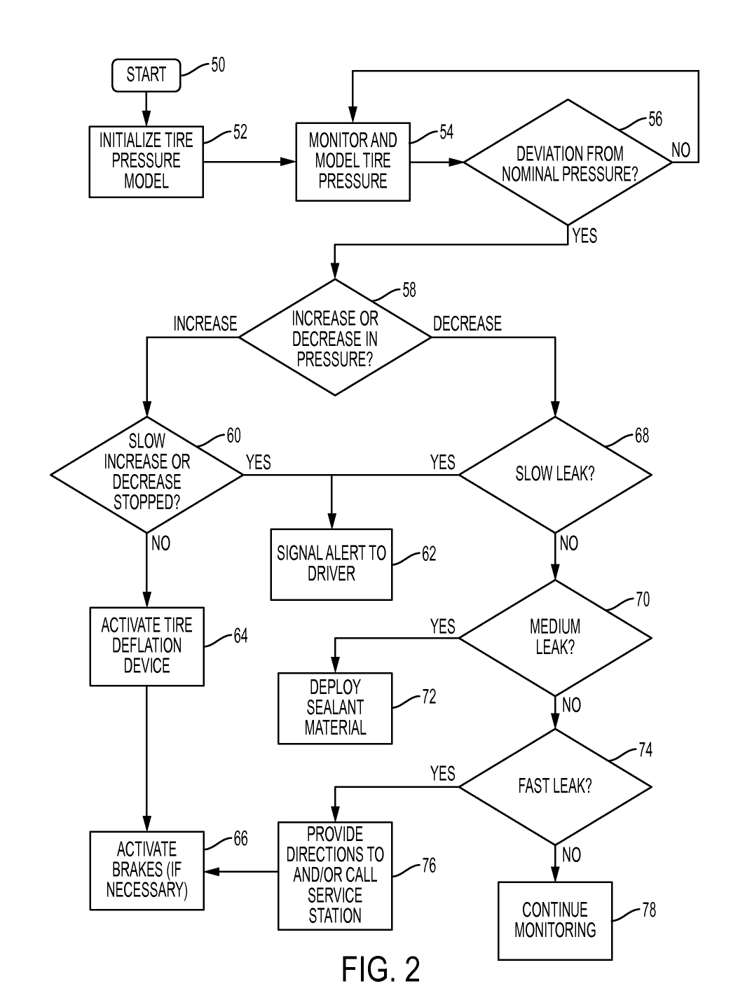

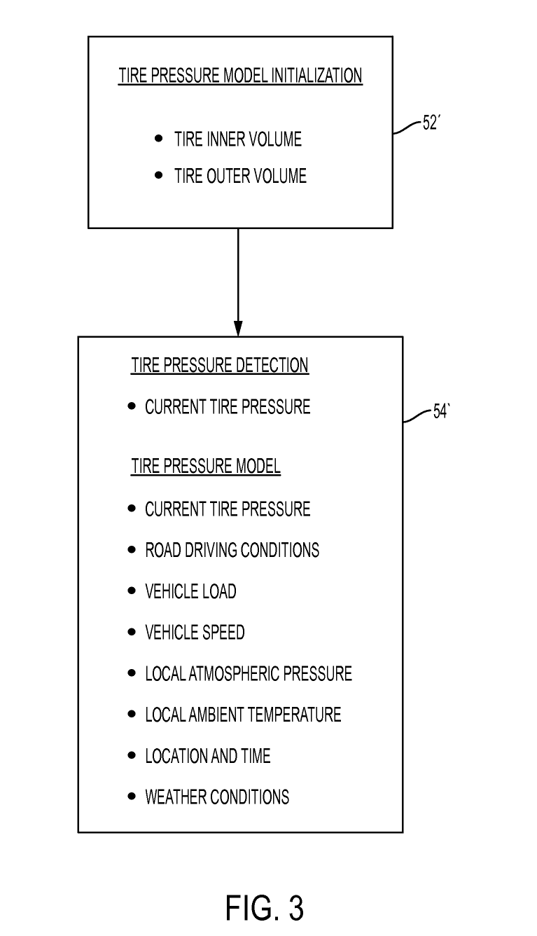

Referring now to FIG. 2, a method of controlling a vehicle according to the present disclosure is shown in flowchart form. The method begins at block 50. A tire pressure model is initialized, as illustrated at block 52. Tire pressure is then monitored and modeled during a drive cycle, as illustrated at block 54. The tire pressure modeling and monitoring will be discussed with reference to FIG. 3.

As may be seen in the exemplary tire model initialization illustrated at block 52′, the tire pressure model may be based on various parameters. The tire pressure model may be initialized based on tire inner volume, which may be calculated based on stored tire specifications such as brand, size, recommended pressure, and/or other parameters. The tire pressure model may also be based on an estimation of the tire outer volume, which may estimated based on the millage and vehicle information. The tire pressure model may also be initialized based on other parameters as appropriate.

As may be seen at block 54′, the tire pressure detection step may include reading and storing the tire pressure value from the tire pressure sensors. In addition, as further shown at block 54′, an expected tire pressure is modeled based on a plurality of parameters.

The tire pressure modeling may include defining the road driving conditions. This may be performed based on sensor readings from suspension, steering, powertrain, and/or restraint control modules. Road driving conditions may influence tire pressure as, for example, during a vehicle turn vehicle weight may shift to the outside tires and may increase pressure in those tires.

In addition, the tire pressure modeling may include defining the vehicle load. This may be based on sensor readings from, for example, seat buckle switches and/or occupant detection systems. An increase in vehicle load may influence tire pressure due to the increase in overall vehicle weight distributed among the tires.

Furthermore, the tire detection modeling may include detecting various other parameters including, but not limited to, the current vehicle speed, the local atmospheric pressure and ambient temperature, current location, date and time, and current weather conditions.

The foregoing are merely exemplary and are not intended to be an exhaustive list of the parameters evaluated during a pressure modeling step. Other appropriate parameters may, of course, be evaluated and used.

Returning to FIG. 2, it may be seen that both a current measured tire pressure and an expected tire pressure based on a tire pressure model are determined at block 54. A determination is then made of whether the current tire pressure deviates from a nominal pressure, as illustrated at operation 56. The nominal pressure may be a manufacturer-provided recommended pressure or other appropriate value. If no, i.e. the current tire pressure is equal to the nominal tire pressure, control returns to the monitoring and modeling step at block 54.

If yes, i.e. the current tire pressure is different from the nominal tire pressure, then a determination is made of whether the current tire pressure is an increase or decrease relative to the nominal tire pressure, as illustrated at operation 58.

If the deviation in tire pressure is an increase in tire pressure, then a determination is made of whether the tire pressure is increasing at a slow rate or has stopped increasing, as illustrated at block 60. This determination may be made, for example, by comparing a current pressure rate change against a pre-determined threshold pressure rate change.

If yes, e.g. the increase in pressure is sufficiently slow or has stopped, then an alert is signaled to the driver, as illustrated at block 62. In various embodiments, the alert may include an audio alert, such as a warning tone or a spoken-word warning. The alert may also include a visual alert, such as a warning light or a text-based warning. In a preferred embodiment, the warning includes detailed information on the cause of the pressure deviation. As an example, if the increase in pressure is due to an increase in vehicle load, the warning may indicate that the current tire pressure is high and is due to the increase in vehicle load. A vehicle operator may then take appropriate corrective action if desired.

In a further preferred embodiment, the alert is modified as the tire pressure changes. As an example, a first alert is signaled to the driver when tire pressure rises a first quantity above the nominal tire pressure, and a distinct second alert is signaled to the driver when the tire pressure rises a second quantity above the nominal tire pressure. The vehicle operator is thus informed of the change in pressure and may take appropriate corrective action if desired.

If no, e.g. the rate of increase in tire pressure exceeds the threshold, then a tire deflation device associated with the affected tire is activated, as illustrated at block 64. In various embodiments, the tire deflation device may be configured to release a pre-set quantity of air or to deflate the tire until the current pressure reaches a threshold pressure.

If the rate of increase in tire pressure exceeds a permissible level, then vehicle brakes may be automatically applied, as illustrated at block 66. This may be performed, for example, in response to the deviation in tire pressure being greater than a maximum permissible threshold.

Returning to operation 58, if the deviation in tire pressure is a decrease in tire pressure, then a determination is made of whether the decrease in tire pressure is due to a slow leak, as illustrated at operation 68. This may be performed, for example, by determining a difference between an expected tire pressure from the tire pressure model and the measured tire pressure. If a positive non-zero difference is calculated, a leak may be inferred. If the difference is less than a first threshold, a slow leak may be inferred.

If yes, then e.g. the decrease in slow pressure is due to a slow leak, then an alert is signaled to the driver, as illustrated at block 62. In various embodiments, the alert may include an audio alert, such as a warning tone or a spoken-word warning. The alert may also include a visual alert, such as a warning light or a text-based warning. In a preferred embodiment, the warning includes detailed information on the cause of the pressure deviation, e.g. that a slow leak has been detected.

In a further preferred embodiment, the alert is modified as the tire pressure changes. As an example, a first alert is signaled to the driver when tire pressure decreases a first quantity above the nominal tire pressure, and a distinct second alert is signaled to the driver when the tire pressure decreases a second quantity above the nominal tire pressure. The vehicle operator is thus informed of the change in pressure and may take appropriate corrective action if desired.

Returning to operation 68, if no slow leak is detected, then a determination is made of whether the decrease in tire pressure is due to a medium leak, as illustrated at operation 70. A medium leak may be inferred if the difference between expected tire pressure from the tire pressure model and the measured tire pressure is greater than the first threshold but less than a second threshold.

If yes, e.g. a medium leak is detected, then sealant material is released, as illustrated at block 72. This may be performed, for example, using tire sealant material devices 28a-d as shown in FIG. 1. As discussed above with respect to FIG. 1, the tire sealant material will be subjected to suction forces due to a pressure difference between the pressure inside the tire and an ambient pressure outside the tire. The suction force will generally drive the material to flow toward the opening. Due to material properties of the tire sealant material and temperature and/or pressure changes from the interior to exterior of the tire, the tire sealant material may adhere to and solidify about a puncture through the wall of the tire. The material may thus build up across the puncture and close it.

Returning to operation 70, if no medium leak is detected, then a determination is made of whether the decrease in tire pressure is due to a fast leak, as illustrated at operation 74. A fast leak may be inferred if the difference between expected tire pressure from the tire pressure model and the measured tire pressure is greater than the second threshold.

If yes, e.g. a fast leak is detected, then directions to a nearby service station are provided to the driver, as illustrated at block 76. This may be performed, for example, using a driver interface 22 as illustrated in FIG. 1. In addition, an automatic call may be placed to a service provider, such as a repair garage, tow service, or other vehicle maintenance service.

If the fast leak exceeds a permissible level, then vehicle brakes may be automatically applied, as illustrated at block 66. This may be performed, for example, in response to the difference between expected tire pressure from the tire pressure model and the measured tire pressure being greater than a maximum permissible threshold.

Returning to operation 74, if no fast leak is detected, e.g. there is a decrease in tire pressure but no difference between the current measured tire pressure and the expected tire pressure obtained from the tire pressure model, then monitoring and modeling continues as illustrated at block 78.

Variations on the above are, of course, possible. For example, detailed driver alerts may be provided in conjunction with each detected deviation from nominal pressure in conjunction with the corrective action illustrated in FIG. 2. As an example, if a medium leak is detected at operation 70, a driver alert may be provided indicating the detected presence of a medium leak and that sealant material has been released.

As may be seen, the present disclosure provides a system and method for signaling detailed information regarding tire pressure to a driver. In addition, systems and methods according to the present disclosure may take various passive and active measures in response to changes in tire pressure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of controlling a vehicle, comprising:
in response to a detected tire pressure deviation from a nominal tire pressure exceeding a first threshold, providing a driver alert; and
in response to the detected tire pressure deviation exceeding a second threshold, distinct from the first threshold, providing audio or visual directions to a service station.

2. The method of claim 1, further comprising in response to the detected tire pressure deviation exceeding a third threshold and the tire pressure deviation being a decrease in tire pressure, automatically releasing sealant material into a tire.

3. The method of claim 2, wherein the third threshold is between the first threshold and the second threshold.

4. The method of claim 3, wherein sealant material is not released when the tire pressure deviation exceeds the second threshold.

5. The method of claim 1, further comprising in response to the detected tire pressure deviation exceeding a fourth threshold, automatically engaging vehicle brakes.

6. The vehicle of claim 1, further comprising in response to the detected tire pressure deviation exceeding a fifth threshold and the tire pressure deviation being an increase in tire pressure, automatically activating a tire deflator.

7. A vehicle comprising:
a tire;
a sensor configured to monitor pressure within the tire; and
a controller configured to signal a driver alert in response to a first reading from the sensor indicating a pressure deviation from a nominal tire pressure exceeding a first threshold and control an audiovisual system to provide audio or visual directions to a service location in response to a second reading indicating the pressure deviation exceeding a distinct second threshold.

8. The vehicle of claim 7, further comprising a sealant material dispenser disposed within the tire, wherein the controller is further configured to control the sealant material dispenser to release sealant material into the tire in response to the pressure deviation exceeding a calibratable third threshold.

9. The vehicle of claim 8, wherein the sealant material dispenser and sensor are integrated into a single module.

10. The vehicle of claim 8, wherein the third threshold is greater than the first threshold and less than the second threshold.

11. The vehicle of claim 10, wherein the controller is configured to control the sealant material dispenser to release sealant material into the tire in response to the pressure deviation exceeding the third threshold only when the pressure deviation is less than the second threshold.

12. The vehicle of claim 7, wherein the controller is further configured to automatically engage vehicle brakes in response to the pressure deviation exceeding a fourth threshold.

13. The vehicle of claim 7, wherein the controller is further configured to automatically activate a tire deflator in response to the pressure deviation exceeding a fifth threshold.

14. A method of controlling a vehicle, comprising:
in response to a magnitude of a detected reduction in tire pressure exceeding a first threshold and not exceeding a second threshold, providing a driver alert;
in response to the magnitude exceeding the second threshold and not exceeding a third threshold, automatically releasing sealant material into a tire; and
in response to the magnitude exceeding the third threshold, automatically providing audio or visual directions to a service station.

15. The method of claim 14, further comprising, in response to the magnitude exceeding a fourth threshold, automatically engaging vehicle brakes.

16. The method of claim 15, further comprising, in response to the magnitude exceeding the fourth threshold, automatically calling a vehicle service location.

17. The method of claim 14, wherein the detected reduction in tire pressure is detected based on a difference between a measured tire pressure and an expected tire pressure based on a tire pressure model.

18. The method of claim 14, further comprising, in response to a magnitude of a detected increase in tire pressure exceeding a fifth threshold and not exceeding a sixth threshold, providing a driver alert; and
in response to the magnitude of the detected increase in tire pressure exceeding the sixth threshold, automatically activating a tire deflator.
